(19) United States
(12) Patent Application Publication
(10) Pub. No.: US 2025/0045614 A1
(43) Pub. Date: Feb. 6, 2025

(54) APPARATUS AND METHOD WITH HYBRID QUANTUM-CLASSICAL NEURAL NETWORK ARCHITECTURE GENERATION

(71) Applicant: Samsung Electronics Co., Ltd., Suwon-si (KR)

(72) Inventors: Whan GHANG, Suwon-si (KR); Min Je KIM, Suwon-si (KR)

(73) Assignee: Samsung Electronics Co., Ltd., Suwon-si (KR)

(21) Appl. No.: 18/531,119

(22) Filed: Dec. 6, 2023

(30) Foreign Application Priority Data
Aug. 2, 2023 (KR) 10-2023-0101075

(51) Int. Cl. G06N 10/20; G06N 10/80

(52) U.S. Cl. CPC G06N 10/20; G06N 10/80

(57) ABSTRACT

An apparatus with hybrid quantum-classical neural network architecture generation includes a generating device configured to generate a hybrid quantum-classical layer based neural network architecture based on setting information for generating a neural network architecture, wherein the generating device comprises a neuron distribution module configured to determine, based on the setting information, whether to distribute neurons in each layer of the neural network into a quantum circuit or a classical circuit, a quantum circuit generation module configured to generate a quantum circuit for the each layer, based on a result of distribution into the quantum circuit, and a classical circuit generation module configured to generate a classical circuit for the each layer, based on a result of distribution into the classical circuit.

### CROSS-REFERENCE TO RELATED APPLICATION(S)

This application claims priority from Korean Patent Application No. 10-2023-0101075, filed on Aug. 2, 2023 in the Korean Intellectual Property Office, the entire disclosure of which is incorporated herein by reference for all purposes.

### BACKGROUND

### 1. Field

The following description relates to an apparatus and method with hybrid quantum-classical neural network architecture generation.

### 2. Description of the Related Art

Quantum computing may include data encoding to convert classical data into quantum data, feature processing to compute parameters with the Ansatz, and measurement to convert quantum data back to classical data. Classical computing may be used to compute new parameters by using an optimizer based on the measured parameters. General Hybrid Quantum-Classical Neural Networks may include classical layers or quantum layers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an apparatus with hybrid quantum-classical neural network architecture generation includes: a generating device configured to generate a hybrid quantum-classical layer based neural network architecture based on setting information for generating a neural network architecture, wherein the generating device comprises: a neuron distribution module configured to determine, based on the setting information, whether to distribute neurons in each layer of the neural network into a quantum circuit or a classical circuit; a quantum circuit generation module configured to generate a quantum circuit for the each layer, based on a result of distribution into the quantum circuit; and a classical circuit generation module configured to generate a classical circuit for the each layer, based on a result of distribution into the classical circuit.

The setting information for generating the architecture may include one or more of a total number of layers of a neural network architecture to be generated, a number of input neurons and output neurons in each layer, a probability that the respective neurons in the each layer are distributed into the quantum circuit or the classical circuit, and a number of output neurons of each of the quantum circuit and the classical circuit in the each layer.

The generating device further may include a consistency verification module configured to verify consistency of the each layer based on the determination of whether to distribute the neurons in the each layer into the quantum circuit or the classical circuit.

The apparatus may include a computing device configured to measure performance of the generated neural network architecture.

The computing device may include: a Central Processing Unit (CPU) configured to measure performance of the classical circuit; and a Quantum Processing Unit (QPU) configured to measure performance of the quantum circuit.

The apparatus may include a quantum controller configured to control quantum states of quantum objects in the QPU, by using quantum technology.

The generating device further may include a performance comparison module configured to determine performance information of the generated neural network architecture by using the computing device, and to determine whether performance of the generated neural network architecture satisfies a target performance by using the determined performance information.

The performance information may include one or more indicators comprising any one or any combination of any two or more of learnability of the generated neural network architecture, training validation accuracy, training time, inference accuracy, and inference time of the generated neural network architecture.

In response to the target performance being satisfied, the performance comparison module may be configured to determine the generated neural network architecture to be a final neural network architecture.

In response to the target performance not being satisfied, the performance comparison module may be configured to store the setting information, result information of generating the neural network architecture, and the performance information in a memory.

The generating device further may include a setting information update module configured to, in response to the target performance not being satisfied: update the setting information by using new setting information; and generate the neural network architecture again.

In response to the target performance not being satisfied, the performance comparison module may be configured to: determine whether a number of times that neural network architectures are generated so far exceeds a predetermined number of times; and in response to the predetermined number of times being exceeded, determine one of the neural network architectures, generated so far, to be a final neural network architecture based on the performance information.

In one or more general aspects, a processor-implemented method with hybrid quantum-classical neural network architecture generation includes: receiving setting information for generating a neural network architecture; and generating a hybrid quantum-classical layer based neural network architecture based on the setting information, wherein the generating of the neural network architecture may include: determining, based on the setting information, whether to distribute neurons in each layer of the neural network into a quantum circuit or a classical circuit; generating a quantum circuit for the each layer, based on a result of distribution into the quantum circuit; and generating a classical circuit for the each layer, based on a result of distribution into the classical circuit.

The setting information for generating the architecture may include any one or any combination of any two or more of a total number of layers of a neural network architecture to be generated, a number of input neurons and output neurons in each layer, a probability that the respective neurons in the each layer are distributed into the quantum circuit or the classical circuit, and a number of output neurons of each of the quantum circuit and the classical circuit in the each layer.

The generating of the neural network architecture further may include verifying consistency of the each layer based on the determination of whether to distribute the neurons in the each layer into the quantum circuit or the classical circuit.

The method may include: determining performance information of the generated neural network architecture by using a computing device; and determining whether performance of the generated neural network architecture satisfies a target performance by using the determined performance information.

The method may include, in response to the target performance not being satisfied, storing the setting information, result information of generating the neural network architecture, and the performance information in a memory.

The method may include, in response to the target performance not being satisfied, updating the setting information by using new setting information, and generating a neural network architecture again based on the updated setting information.

The method may include, in response to the target performance not being satisfied, determining whether a number of times that neural network architectures are generated so far exceeds a predetermined number of times, and in response to the predetermined number of times being exceeded, determining one of the neural network architectures, generated so far, to be a final neural network architecture based on the performance information.

In one or more general aspects an electronic device includes: a neural network device including a hybrid quantum-classical neural network architecture generated by an apparatus for generating a hybrid quantum-classical neural network architecture; and one or more processors configured to operate the hybrid quantum-classical neural network device, and to perform any one or any combination of any two or more of image processing, natural language processing, and applying artificial intelligence and machine learning, wherein the hybrid quantum-classical neural network is generated by stochastically distributing neurons in one or more layers of the neural network into both a quantum circuit and a classical circuit.

Other features and aspects will be apparent from the following detailed description, the drawings, and the claims.

### BRIEF DESCRIPTION OF THE DRAWINGS

FIG. 1 is a block diagram illustrating an apparatus for generating a hybrid quantum-classical neural network architecture according to one or more embodiments.

FIG. 2 is a block diagram illustrating a generating device of FIG. 1, according to one or more embodiments.

FIG. 3 is a diagram illustrating a hybrid quantum-classical neural network architecture according to one or more embodiments.

FIG. 4 is a diagram illustrating a hybrid quantum-classical neural network architecture according to one or more embodiments.

FIG. 5 is a flowchart illustrating a method of generating a hybrid quantum-classical neural network architecture according to one or more embodiments.

FIG. 6 is a flowchart illustrating an example of generating a hybrid quantum-classical neural network architecture according to one or more embodiments.

FIGS. 7A and 7B are flowcharts illustrating a method of generating a hybrid quantum-classical neural network architecture according to one or more embodiments.

FIG. 8 is a block diagram illustrating an electronic device according to one or more embodiments.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known, after an understanding of the disclosure of this application, may be omitted for increased clarity and conciseness.

The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Throughout the specification, when an element is described as “connected to” or “coupled to” another element, it may be directly “connected to” or “coupled to” the other component, or there may be one or more other components intervening therebetween. In contrast, when an element is described as “directly connected to” or “directly coupled to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish one member, component, region, layer, or section from another member, component, region, layer, or section. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

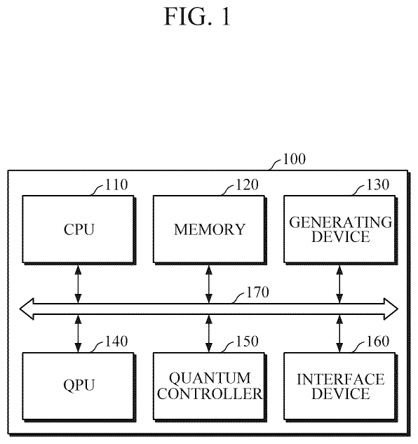

FIG. 1 is a block diagram illustrating an apparatus for generating a hybrid quantum-classical neural network architecture according to one or more embodiments. Hereinafter, the term, “hybrid quantum-classical neural network architecture,” will be referred to as a “hybrid neural network architecture.”

Referring to FIG. 1, an apparatus 100 for generating a hybrid neural network architecture may include a Central Processing Unit (CPU) 110 (e.g., one or more processors), a memory 120 (e.g., one or more memories), a generating device 130, a Quantum Processing Unit (QPU) 140, a quantum controller 150, and an interface device 160. The respective components of the apparatus 100 for generating a hybrid neural network architecture may be connected via a bus 170 to communicate with each other.

The CPU 110 may control the overall operation of the apparatus 100 for generating a hybrid neural network architecture. The CPU 110 may include one or a plurality of processor cores. The CPU 110 may execute various instructions and/or programs stored in the memory 120.

The memory 120 may store instructions and/or data for controlling the overall operation of the apparatus 100 for generating a hybrid neural network architecture. The data may include input information and setting information used in generating a hybrid neural network architecture by the respective components of the apparatus 100 for generating a hybrid neural network architecture, processing results of the respective components, and the like. The instructions and/or data stored in the memory 120 may be transmitted to the generating device 130 under the control the CPU 110. The memory 120 may include Random Access Memory (RAM), such as Dynamic Random Access Memory (DRAM), Static Random Access Memory (SRAM), etc., flash memory, cache memory, virtual memory, etc., but is not limited thereto. In an example, the memory 120 may be or include a non-transitory computer-readable storage medium storing instructions that, when executed by the generating device 130, configure the generating device 130 to perform any one, any combination, or all of operations and methods of the generating device 130 described herein with reference to FIGS. 1-8.

The generating device 130 may generate a hybrid neural network architecture under the control of the CPU 110 by using the instructions and/or data transmitted from the memory 120. The hybrid neural network architecture may be generated such that at least some layers thereof may include both a quantum circuit and a classical circuit. For example, the hybrid neural network architecture may be generated such that all intermediate hidden layers may include both the quantum circuit and the classical circuit, or some hidden layers include only one of the quantum circuit and the classical circuit, and the remaining hidden layers may include both the quantum circuit and the classical circuit. The generated hybrid neural network architecture may be implemented in the form of an application-specific integrated circuit (ASIC) chip to be embedded in a quantum computer, for use in image recognition/detection, natural language processing, and the like. The generating device 130 may include one or more processors.

The QPU 140 is a device that performs quantum computation by using quantum technology, and may include a quantum system. The quantum system may include quantum objects, such as atoms, ions, neutrons, protons, photons, electrons, and the like. States of quantum objects may be represented by quantum bits (qubits), such as the bits of a classical computer, in terms of information processing. The QPU 140 may include quantum gates constituting a quantum circuit. The QPU 140 may perform information processing on quantum objects by entanglement in quantum mechanics. Topological states of the quantum objects in the QPU 140 are changed by the quantum controller 150, and the QPU 140 measures the change in topological information of the quantum objects, to obtain (e.g., generate or determine) a result of quantum processing which is transformed into classical data.

The quantum controller 150 may include quantum technology, such as superconductivity technology, ion trap technology, and optical technology, and may control quantum states of the quantum objects by using the quantum technology. Here, the quantum technology is not limited to the illustrated quantum technology, but includes all techniques for creating quantum objects using quantum mechanics. The quantum controller 150 may change the topological states of the quantum objects in the QPU 140.

The interface device 160 may perform communication with an external device. The external device may include a system, such as another hybrid quantum-classical system or a classical or quantum computer, or network equipment such as repeaters, hubs, bridges, routers, and the like. The interface device 160 may use a communication protocol, such as Hypertext Transfer Protocol (HTTP), File Transfer Protocol (FTP), Secure Shell (SSH), Simple Object Access Protocol (SOAP), etc., but is not limited thereto.

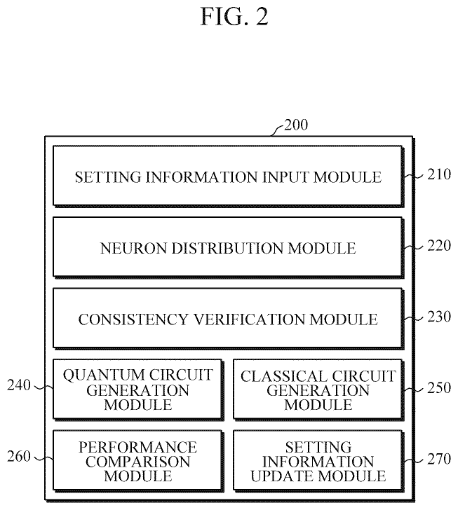

FIG. 2 is a block diagram illustrating a generating device according to one or more embodiments.

Referring to FIG. 2, a generating device 200 (e.g., the generating device 130) may include a setting information input module 210, a neuron distribution module 220, a consistency verification module 230, a quantum circuit generation module 240, a classical circuit generation module 250, a performance comparison module 260, and a setting information update module 270.

The setting information input module 210 may store a variety of setting information, used for generating a hybrid neural network architecture, in the memory 120. The setting information may be input by a user. The setting information may include the total number of layers in the hybrid neural network architecture, the number of input neurons and output neurons in each layer, and the like. In an example, the number of input neurons in a first layer of the hybrid neural network architecture may be set to be equal to a size of an input of the hybrid neural network architecture, and the number of output neurons in a last layer of the hybrid neutral network architecture may be set to be equal to a size of an output of the hybrid neural network architecture. In intermediate hidden layers, the number of input neurons in a current layer may be set to be equal to the number of output neurons in a previous layer, and the number of output neurons in the current layer may be set to be equal to the number of input neurons in a next layer.

In addition, the setting information may include a probability for determining whether the respective neurons are distributed into a quantum circuit or a classical circuit for each layer. For example, a probability P_{i,j} may be defined as a probability that a j-th neuron in layer i is distributed into the quantum circuit. In an example, a probability 1−p_{i,j} may indicate a probability that the j-th neuron is distributed into the classical circuit. The opposite is also possible.

Further, the setting information may include the number qᵢ of output neurons of the quantum circuit and the number cᵢ of output neurons of the classical circuit in each layer. Here, qᵢ+cᵢ may be set to be equal to the total number of output neurons in layer i. In addition, the number of output neurons of the quantum circuit may be set to be equal to or different from the number of quantum neurons. Likewise, the number of output neurons of the classical circuit may be set to be equal to or different from the number of classical neurons. For example, the output neurons in the quantum circuit may be set to be greater in number than the quantum neurons, and the output neurons in the classical circuit may be smaller in number than the classical neurons. Here, the term, “quantum neurons,” may refer to neurons in each layer that are distributed into the quantum circuit, and the term, “classical neurons,” may refer to neurons in each layer that are distributed into the classical circuit.

The neuron distribution module 220 may stochastically determine whether to distribute the respective neurons in layers, constituting the quantum circuit and/or the classical circuit, into the quantum circuit and/or the classical circuit, by reference to the probability in the setting information. In an example, a random number generator may be used.

The consistency verification module 230 may verify consistency of each layer based on a result of distributing the respective neurons in layers into the quantum circuit or the classical circuit by the neuron distribution module 220.

For example, when layer i has only the quantum neurons, the consistency verification module 230 may check whether cᵢ=0. Here, cᵢ may denote the number of output neurons in the classical circuit. When cᵢ≠0 when all the neurons in layer i are distributed into the quantum circuit, the consistency verification module 230 may determine that the neural network architecture is inconsistent. Upon determining that the result of distributing the neurons in layer i is inconsistent, the consistency verification module 230 may notify a user of an error, and return to the neuron distribution module 220 to distribute the neurons for layer i again.

In another example, when layer i has only the classical neurons, the consistency verification module 230 may check whether qᵢ=0. Here, qᵢ may denote the number of output neurons in the quantum circuit. When qᵢ≠0 when all the neurons in layer i are distributed into the classical circuit, the consistency verification module 230 may determine that the neural network architecture is inconsistent. Upon determining that the result of distributing the neurons in layer i is inconsistent, the consistency verification module 230 may notify a user of an error, and return to the neuron distribution module 220 to distribute the neurons for layer i again.

When the neuron distribution module 220 selects input neurons and output neurons of the quantum circuit for each layer, and the consistency verification module 230 determines that the distribution result is consistent, the quantum circuit generation module 240 may generate a quantum circuit by connecting quantum gates, a measurement circuit, and the like. The quantum gates may be a basic unit of operation for encoding the quantum objects in the quantum circuit and changing the state of quantum bits (qubits) by using quantum neurons as classical data, and may include, for example, Pauli-X, Pauli-Y, Pauli-Z, Controlled-NOT (CNOT), Hadamard, Phase (P), Identity (I), S, T, Rx, Ry, Rz, and the like. The measurement circuit may be designed according to the characteristics and needs of a method applied, such as superconductivity technology, ion trap technology, and the like. In the superconductivity technology, the state of quantum bits may be measured by identifying the frequency of quantum objects. In addition, in the ion trap technology, the state of quantum bits may be measured by measuring internal energy of an ion.

When the neuron distribution module 220 selects input neurons and output neurons of the classical circuit for each layer, and the consistency verification module 230 determines that the distribution result is consistent, the classical circuit generation module 250 may connect the classical neurons with the output neurons and may generate a classical circuit for computing weights and performing Batch Normalization and/or Activation, and the like. The weights may be computed by a sum of linear combinations of input neuron values and weight values. The classical circuit may be implemented with classical gates such as AND, OR, NAND, NOR, XOR, XNOR, ADDER TREE, and MUX.

The performance comparison module 260 may measure performance of the hybrid neural network architecture generated by using a computing device (e.g., the CPU 110 and the QPU 140) based on the setting information, and may determine a final hybrid neural network architecture based on the measured performance. Information about the generated classical circuit of the hybrid neural network architecture may be transmitted to the CPU 110, and information about the generated the quantum circuit of the hybrid neural network architecture may be transmitted to the QPU140. The computing device (e.g., the CPU 110 and the QPU 140) may obtain performance indicators, such as learnability, training validation accuracy, training time, inference accuracy, inference time, etc., by training and inference of the generated hybrid neural network architecture.

When performance of the generated hybrid neural network architecture satisfies a predetermined target performance, the performance comparison module 260 may determine the hybrid neural network architecture to be a final hybrid neural network architecture. For example, when all performance indicators are greater than or equal to corresponding target performance values, or when a mean value or a total sum of the performance indicators, or a weighted sum thereof obtained by applying weights set according to importance, or the like is greater than or equal to a predetermined target performance value, the performance comparison module 260 may determine that the performance satisfies the target performance. The target performance, criteria for determination, and the like are not limited to the illustrated example, and may be set to various values by a user.

When performance of the generated hybrid neural network architecture does not satisfy the target performance, the performance comparison module 260 may write setting information of the generated hybrid neural network architecture, result information, performance indicators, and the like to the memory 120. Further, the performance comparison module 260 may change setting information by using the setting information update module 270, and may request other modules to generate a next hybrid neural network architecture by using the changed setting information. The performance comparison module 260 may perform the same performance comparison process for the generated next hybrid neural network architecture, in which case when a process of generating the hybrid neural network architecture is repeated more than a predetermined number of times, the performance comparison module 260 may select a hybrid neural network architecture with best performance as a final hybrid neural network architecture, from among hybrid neural network architectures generated so far. However, the present disclosure is not limited to these examples.

The setting information update module 270 may change the setting information to setting information for generating a next hybrid neural network architecture, in response to a request from the performance comparison module 260. The setting information update module 270 may change the setting information in response to a user input or according to predetermined criteria for changing the information. The setting information update module 270 may provide a user interface for a user, and may receive setting information from the user through the user interface.

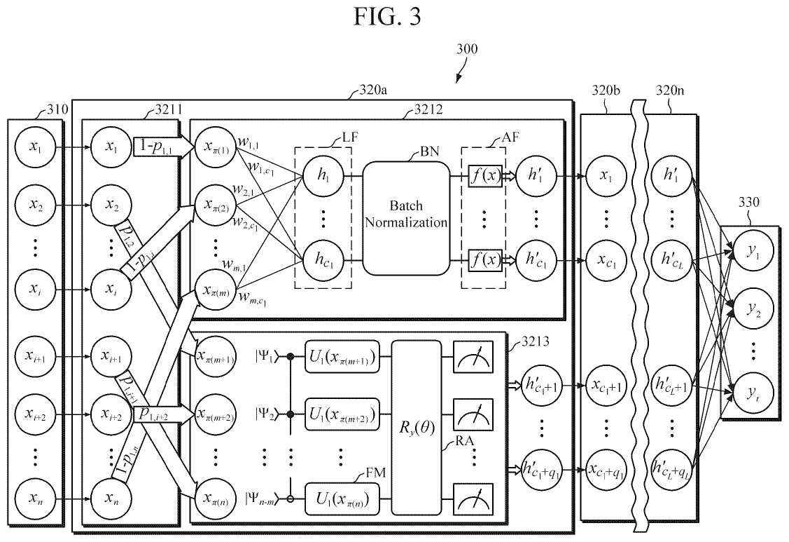

FIG. 3 is a diagram illustrating a hybrid neural network architecture according to one or more embodiments.

Referring to FIG. 3, an example is illustrated in which a hybrid neural network architecture 300 consists of a first input layer 310 having n number of input neurons x₁, x₂, . . . , xₙ, and a last layer 330 having t number of output neurons y₁, y₂, . . . , yₜ. There may be input neurons and/or output neurons in each of intermediate hidden layers 320a, 320b, . . . , and 320n.

The neuron distribution module 220 may stochastically divide the neurons in each layer into two groups, and may distribute one divided group into the quantum circuit and the other group into the classical circuit. When dividing the neurons into the quantum circuit and the classical circuit, the neuron distribution module 220 may use hyper parameter setting information, pᵢⱼ, qᵢ, and cᵢ.

pᵢⱼ is a probability that a j-th neuron in layer i is distributed into the quantum circuit, and is a real number between 0 and 1. pᵢⱼ is a parameter of a real number freely determined between 0 and 1, in which when the number is 1, the j-th neuron in layer i enters (e.g., is included in) the quantum circuit with 100% probability, and when the number is 0, a corresponding neuron enters the classical circuit with 100% probability.

qᵢ is the number of output neurons of the quantum circuit in layer i and is a non-negative integer. cᵢ is the number of output neurons of the classical circuit in layer i and is a non-negative integer. qᵢ, cᵢ may be defined to satisfy the following conditions, when stochastic distribution is complete according to the probability of pᵢⱼ for layer i: first, qᵢ=0 when there is no neuron entering the quantum circuit; second, cᵢ=0 when there is no neuron entering the classical circuit; third, qᵢ+cᵢ>0; and fourth, q_{L}+C_{L}=t in a last hidden layer. Herein, t indicates the total number of output neurons, q_{L}, indicates the number of output neurons of the quantum circuit, and c_{L} indicates the number of output neurons of the classical circuit, in the last hidden layer.

With reference to a first hidden layer 320a in the hybrid neural network architecture 300 of FIG. 3 as an example, when there are n number of input neurons x₁, x₂, . . . , xₙ 3211 in the first hidden layer 320a, the input neurons x₁, x₂, . . . , xₙ 3211 are stochastically divided by the neuron distribution module 220 into neurons entering a classical circuit 3212 and neurons entering a quantum circuit 3213 according to a probability of p_{1,j} (j=1, . . . , n). In an example, when there is a certain permutation π as a result of the division, neurons x_{π(1)}, x_{π(2)}, . . . , x_{π(m)} enter the classical circuit 3212, and neurons x_{π(m+1)}, x_{π(m+2)}, . . . , x_{π(n)} enter the quantum circuit 3213. For convenience of explanation, FIG. 3 illustrates an example in which the input neurons x₁, x₂, . . . , xₙ in the first hidden layer 320a are illustrated separately from the neurons x_{π(1)}, x_{π(2)}, . . . , x_{π(m)} entering the classical circuit and the neurons x_{π(m+1)}, x_{π(m+2)}, . . . , x_{π(n)} entering the quantum circuit, but in the hybrid neural network architecture 300 generated in practice, there are only neurons after being distributed into the classical circuit and the quantum circuit.

In the classical circuit 3212 generated by the classical circuit generation module 250, the input neurons x_{π(1)}, x_{π(2)}, . . . , x_{π(m)} are passed to a layer of neurons h₁, h₂, . . . , h_{c1} through, for example, linear calculation (LF). In an example, the linear calculation (LF) may be defined as in the following Equation 1 below, for example, where w_{i,k} denotes a weight. When the input neurons x_{π(1)}, x_{π(2)}, . . . , x_{π(m)} are passed to a layer of neurons h₁, h₂, . . . , h_{c1}, batch normalization (BN) may be performed. When BN is performed, output neurons h′₁, h′₂, . . . , h′_{c1} may be generated as a result of using an activation function (AF).

$${h}_{k} = {\sum }_{i = 1}^{m} {x}_{π ( i )} {w}_{i , k} \qquad Equation 1$$

The output neurons h′₁, h′₂, . . . , h′_{c1} in the first hidden layer 320a act as input neurons x₁, x₂, . . . , x_{c1} in a second hidden layer 320b.

In the quantum circuit 3213 generated by the quantum circuit generation module 240, for example, input neurons xx (m+1), Xx (m+2), . . . , Xx (n) may be converted to the rotation angle of a feature map (FM), e.g., ZZFeatureMap used in quantum computing, followed by encoding into quantum gates. A quantum space may be detected by using quantum gates with rotation angle as weight to be learned, as well as quantum gates, such as CNOT, used in entanglement. Further, RealAmplitudes, in which the rotation angle as weight to be learned is input, may be connected to the quantum gates. By measuring the quantum circuit 3213 formed by connecting the quantum gates and the RealAmplitude gates, expected values of various observables, such as Z⊗I⊗I, Z⊗I⊗Z, Z⊗Z⊗Z may be given as output. Here, Z⊗I⊗I and the like may denote tensor product of quantum gates (Pauli-Z gate, I gate). The expected values of the respective observables may be obtained as a mean value of multiple measurements of the quantum circuit 3213. Output neurons h′_{c1+1}, h′_{c1+2}, . . . , h′_{c1+q1} for outputting the obtained values act as the input neurons x_{c1+1}, x_{c1+2}, . . . , c_{c1+q1} of the second hidden layer 320b.

By stacking the hidden layers in this manner, a result of a last hidden layer 320n may enter input neurons y₁, y₂, . . . , yₜ in the last layer 330.

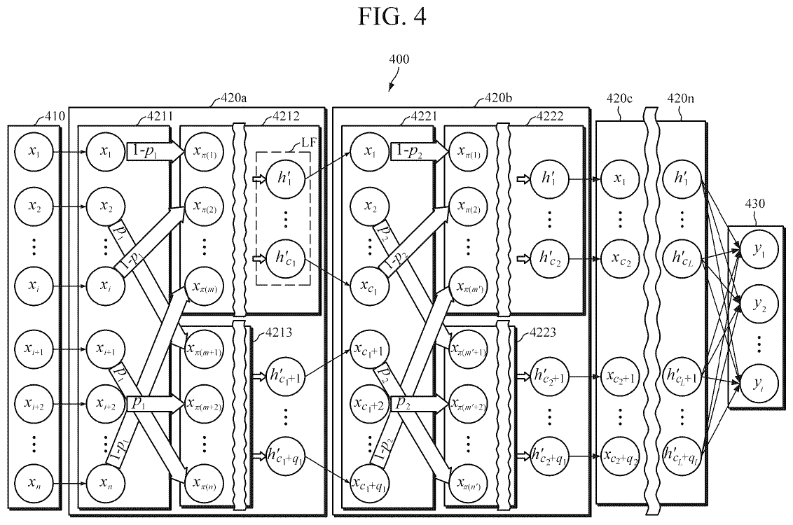

FIG. 4 is a diagram illustrating a hybrid neural network architecture according to one or more embodiments.

A hybrid neural network architecture 400 of FIG. 4 consists of a first input layer 410, one or more intermediate hidden layers 420a, 420b, 420c, . . . , 420n, and a last output layer 430, as in FIG. 3. Input neurons 4211 and 4221 in the respective hidden layers 420a, 420b, 420c, . . . , 420n are stochastically distributed into classical circuits 4212 and 4222 and quantum circuits 4213 and 4223 by the neuron distribution module 220, and the classical circuits 4212 and 4222 and the quantum circuits 4213 and 4223 are generated by the quantum circuit generation module 240 and the classical circuit generation module 250.

In the embodiment of FIG. 4, unlike FIG. 3, a probability p_{i,j} that a j-th neuron in the hidden layer i is distributed into the quantum circuits 4213 and 4223 may be a constant. That is, by having a constant probability p_{i,j} for j, all neurons in each layer may be distributed into the quantum circuits with the same probability (pᵢ) and may be distributed independently with a probability of (1-pᵢ) into the classical circuits. In this manner, the neural network architecture may be constructed such that paths from the input layer to the last layer are not biased to the quantum circuits or the classical circuits.

For convenience of explanation, FIG. 4 illustrates an example in which the input neurons x₁, x₂, . . . , xₙ in a first hidden layer 420a are illustrated separately from the neurons x_{π(1)}, x_{π(2)}, . . . , x_{π(m)} entering the classical circuits and the neurons x_{π(m+1)}, x_{π(m+2)}, . . . , x_{π(n)} entering the quantum circuits, but in the hybrid neural network architecture 400 generated in practice, there are only neurons after being distributed into the classical circuits and the quantum circuits.

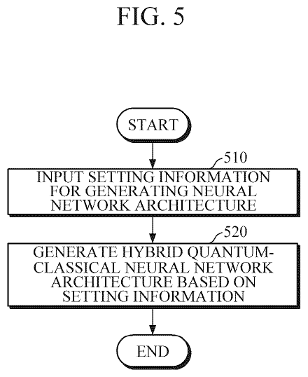

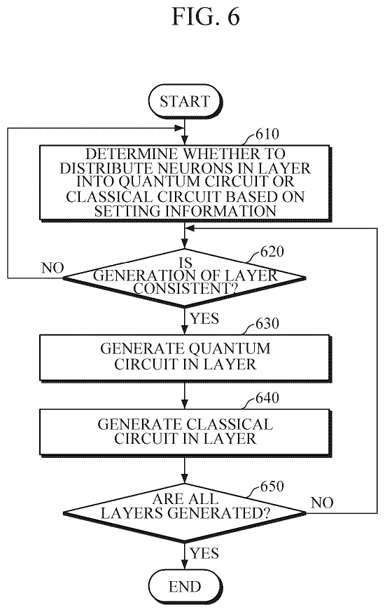

FIG. 5 is a flowchart illustrating a method of generating a hybrid neural network architecture according to one or more embodiments. While the operations of FIG. 5 may be performed in the shown order and manner, the order of one or more of the operations may be changed, one or more of the operations may be omitted, and/or one or more of the operations may be performed in parallel or simultaneously, without departing from the spirit and scope of the shown example. FIG. 6 is a flowchart illustrating an example of generating a hybrid neural network architecture according to one or more embodiments. While the operations of FIG. 6 may be performed in the shown order and manner, the order of one or more of the operations may be changed, one or more of the operations may be omitted, and/or one or more of the operations may be performed in parallel or simultaneously, without departing from the spirit and scope of the shown example.

FIGS. 5 and 6 are an example of generating a hybrid neural network architecture which is performed by the apparatus 100 for generating a hybrid neural network architecture in FIG. 1, which is described in detail above, and thus will be briefly described below in order to avoid redundancy.

First, the apparatus 100 for generating a hybrid neural network architecture may receive setting information for generating a hybrid neural network architecture in operation 510. The setting information may be input by a user. The setting information may include the total number of layers in the hybrid neural network architecture, the number of input neurons and output neurons in each layer, the number of output neurons, a probability that the respective neurons in each layer are distributed into the quantum circuit, the numbers qᵢ, cᵢ of output neurons of the quantum circuit and the classical circuit, respectively, in each layer. However, the setting information is not limited thereto.

When operation 510 is performed, the apparatus 100 for generating a hybrid neural network architecture may generate a hybrid neural network architecture based on the setting information in operation 520.

Referring to FIG. 6, the operation in 520 of generating the hybrid neural network architecture may include stochastically determining whether to distribute neurons in layers, constituting the quantum circuit and/or the classical circuit, into the quantum circuit and/or the classical circuit, based on the setting information in operation 610. In an example, the number and position of classical and quantum neurons in the layers are determined.

Based on a result of the distribution in operation 610, the apparatus 100 for generating a hybrid neural network architecture may determine whether the distribution of the neurons in the layers is consistent in operation 620. For example, when there are no quantum neurons or classical neurons in a specific layer, when an output of a quantum circuit or a classical circuit has a size equal to or greater than 1, the apparatus 100 for generating a hybrid neural network architecture may determine that there is an error. Upon determining that the distribution is inconsistent, the apparatus 100 for generating a hybrid neural network architecture may change the setting information and may perform operation 610 of distributing the neurons again.

Subsequently, upon determining that the distribution is consistent, the apparatus 100 for generating a hybrid neural network architecture may generate the quantum circuit and the classical circuit in layers respectively in operations 630 and 640. The apparatus 100 for generating a hybrid neural network architecture may determine whether generation of the quantum circuit and the classical circuit is complete for all the layers in operation 650, and when there is a next layer for which the circuits are to be generated, the apparatus 100 for generating a hybrid neural network architecture may perform operations 620 and 630 of generating the quantum circuit and the classical circuit.

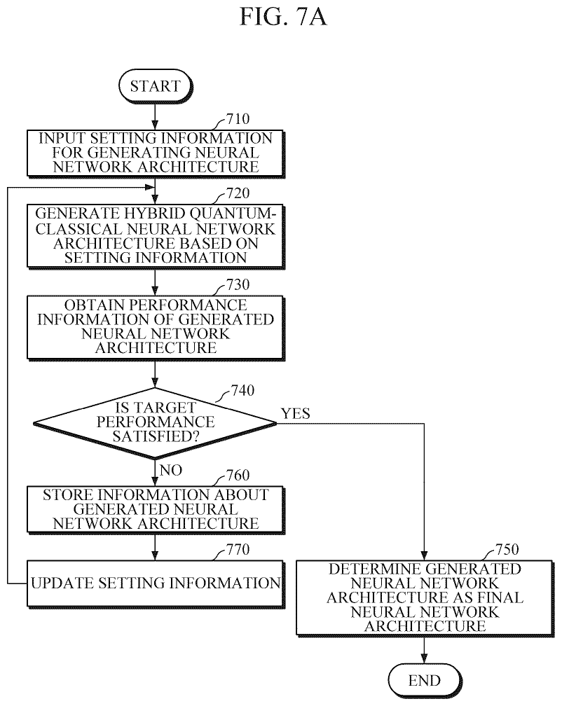

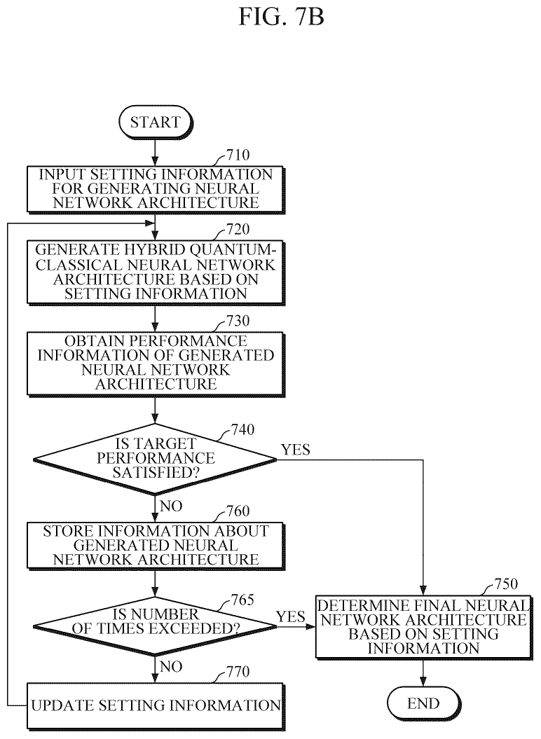

FIGS. 7A and 7B are flowcharts illustrating a method of generating a hybrid neural network architecture according to other embodiments of the present disclosure. While the operations of FIGS. 7A and 7B may be performed in the shown order and manner, the order of one or more of the operations may be changed, one or more of the operations may be omitted, and/or one or more of the operations may be performed in parallel or simultaneously, without departing from the spirit and scope of the shown example.

Referring to FIGS. 7A and 7B, the apparatus for generating a hybrid neural network architecture may receive setting information for generating a hybrid neural network architecture in operation 710, and may generate the hybrid neural network architecture based on the setting information in operation 720.

Then, the apparatus for generating a hybrid neural network architecture may obtain performance information of the generated hybrid neural network architecture in operation 730. By transmitting the generated hybrid neural network architecture to a computing device (CPU and QPU), the apparatus for generating a hybrid neural network architecture may obtain the performance information in operation 740. Information about the generated classical layer in the generated neural network architecture is transmitted to the CPU, and information about the generated quantum layer is transmitted to the QPU.

Subsequently, when a performance indicator, measured by the computing device (CPU and QPU), satisfies a final target performance set by a user, the apparatus for generating a hybrid neural network architecture may determine the hybrid neural network architecture, generated in operation 720, to be a final hybrid neural network architecture in operation 750. When the performance indicator does not satisfy the target performance, the apparatus for generating a hybrid neural network architecture may store setting information about the generated hybrid neural network architecture, result information, performance information, and the like in the memory 120 in operation 760, and may update the setting information for generating a hybrid neural network architecture in operation 770, and may repeat operation 720 of generating a new hybrid neural network architecture based on the updated setting information, and subsequent operations. Referring to FIG. 7B, after storing the information about the generated hybrid neural network architecture in operation 760, the apparatus for generating a hybrid neural network architecture may further perform an operation of comparing a predetermined number of times of generating a hybrid neural network architecture in operation 765. When the predetermined number of times is exceeded, the apparatus for generating a hybrid neural network architecture no longer performs the operation of generating a new hybrid neural network architecture, and may determine in operation 750 a hybrid neural network architecture with best performance to be a final hybrid neural network architecture, among hybrid neural network architectures generated so far.

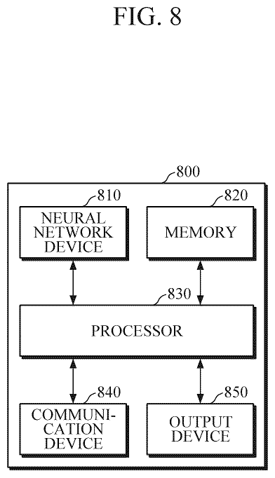

FIG. 8 is a block diagram illustrating an electronic device according to one or more embodiments.

An electronic device 800 may include the hybrid neural network architecture, generated by the apparatus 100 for generating a hybrid neural network architecture, in the form of a hardware chip or a software module. The electronic device 800 may use the hybrid neural network architecture in various applications, ranging from various image processing operations (e.g. image recognition/detection, conversion of low-resolution image quality to high-resolution image quality, frame interpolation, motion vector estimation, feature map generation, etc.) to natural language processing used in in various fields, such as speech recognition, machine translation, sentiment analysis, document classification, etc., and artificial intelligence or machine learning. In addition, the electronic device 800 may also include an apparatus for generating a hybrid neural network architecture, and by using the apparatus for generating a hybrid neural network architecture, the electronic device 800 may generate an optimal hybrid neural network architecture that is suitable for a field and/or purpose of use of the hybrid neural network architecture.

Referring to FIG. 8, the electronic device 800 may include a neural network device 810, a memory 820 (e.g., one or more memories), a processor 830 (e.g., one or more processors), a communication device 840, and an output device 850. In addition, the electronic device 800 may further include an image capturing device for acquiring images, a sensor device (e.g., acceleration sensor, gyroscope, magnetic field sensor, proximity sensor, illuminance sensor, fingerprint sensor, etc.) configured to detect various data, an input device (e.g., a microphone, a mouse, a keyboard, and/or a digital pen (e.g., a stylus pen, etc.), etc.) configured to receive instructions and/or data to be used from a user, and the like.

The neural network device 810 may be a hybrid neural network architecture, generated by the above apparatus for generating a hybrid neural network architecture, in the form of a hardware chip or a software module. The hybrid neural network architecture may be generated by stochastically distributing neurons in layers into a quantum circuit or a classical circuit. In an example, at least some layers may include both the quantum circuit and the classical circuit.

The memory 820 may store instructions executed by the processor 830. In addition, the memory 820 may store processing results of the processor 830, data input by a user through the input device, image data acquired by the image capturing device, or data received from a connected external device through the communication device. The memory 820 may include Random Access Memory (RAM), such as Dynamic Random Access Memory (DRAM), Static Random Access Memory (SRAM), etc., flash memory, cache memory, virtual memory, etc., but is not limited thereto. In an example, the memory 820 may be or include a non-transitory computer-readable storage medium storing instructions that, when executed by the processor 830, configure the processor 830 to perform any one, any combination, or all of operations and methods described herein with reference to FIGS. 1-8.

The processor 830 may execute instructions stored in the memory 820 in response to a user request, and may perform various user requests, such as natural language processing, image processing, and the like by using the neural network device 810. The processor 830 may include a main processor, e.g., a central processing unit (CPU) or an application processor (AP), etc., an intellectual property (IP) core, and an auxiliary processor, e.g., a graphics processing unit (GPU), an image signal processor (ISP), a sensor hub processor, or a communication processor (CP), etc., which is operable independently from, or in conjunction with, the main processor. Further, the processor 830 may include a Quantum Processing Unit (QPU) and a quantum controller.

The communication device 840 may support establishment of a direct (e.g., wired) communication channel and/or a wireless communication channel between the electronic device and other electronic device, a server, or the sensor device within a network environment, and performing of communication via the established communication channel, by using various communication techniques. The communication device 840 may transmit the data processed by the processor 830 and/or the images captured by the image capturing device, and the like to another electronic device. In addition, the communication device 840 may receive data, such as images to be processed or natural language, from a cloud device or another electronic device, and may store the received data in the memory 820.

The output device 850 may visually/non-visually output the data processed by the processor 830 and/or the images captured by the image capturing device. The output device 850 may include a sound output device, a display device (e.g., display), an audio module, and/or a haptic module.

The image capturing device may include a device, such as a camera and the like, for capturing still images or moving images, etc., and may store the captured images in the memory 820. The image capturing device may include a lens assembly having one or more lenses, image sensors, image signal processors, and/or flashes. The lens assembly included in a camera module may collect light emanating from a subject to be imaged.

The input device may receive data and/or instructions to be processed by the processor 830. The input device may include a control button provided on the electronic device 800, a touch screen of a display, a microphone, a mouse, a keyboard, and/or a digital pen (e.g., a stylus pen, etc.), and the like.

The apparatuses, CPUs, memories, generating devices, QPUs, quantum controllers, interface devices, generating devices, setting information input modules, neuron distribution modules, consistency verification modules, quantum circuit generation modules, classical circuit generation modules, performance comparison modules, setting information update modules, electronic devices, neural network devices, processors, communication devices, output devices, apparatus 100, CPU 110, memory 120, generating device 130, QPU 140, quantum controller 150, interface device 160, generating device 200, setting information input module 210, neuron distribution module 220, consistency verification module 230, quantum circuit generation module 240, classical circuit generation module 250, performance comparison module 260, setting information update module 270, electronic device 800, neural network device 810, memory 820, processor 830, communication device 840, output device 850, and other apparatuses, devices, units, modules, and components disclosed and described herein with respect to FIGS. 1-8 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An apparatus with hybrid quantum-classical neural network architecture generation, the apparatus comprising:
a generating device configured to generate a hybrid quantum-classical layer based neural network architecture based on setting information for generating a neural network architecture,
wherein the generating device comprises:
a neuron distribution module configured to determine, based on the setting information, whether to distribute neurons in each layer of the neural network into a quantum circuit or a classical circuit;
a quantum circuit generation module configured to generate a quantum circuit for the each layer, based on a result of distribution into the quantum circuit; and
a classical circuit generation module configured to generate a classical circuit for the each layer, based on a result of distribution into the classical circuit.

2. The apparatus of claim 1, wherein the setting information for generating the architecture comprises one or more of a total number of layers of a neural network architecture to be generated, a number of input neurons and output neurons in each layer, a probability that the respective neurons in the each layer are distributed into the quantum circuit or the classical circuit, and a number of output neurons of each of the quantum circuit and the classical circuit in the each layer.

3. The apparatus of claim 1, wherein the generating device further comprises a consistency verification module configured to verify consistency of the each layer based on the determination of whether to distribute the neurons in the each layer into the quantum circuit or the classical circuit.

4. The apparatus of claim 1, further comprising a computing device configured to measure performance of the generated neural network architecture.

5. The apparatus of claim 4, wherein the computing device comprises:
a Central Processing Unit (CPU) configured to measure performance of the classical circuit; and
a Quantum Processing Unit (QPU) configured to measure performance of the quantum circuit.

6. The apparatus of claim 5, further comprising a quantum controller configured to control quantum states of quantum objects in the QPU, by using quantum technology.

7. The apparatus of claim 4, wherein the generating device further comprises a performance comparison module configured to determine performance information of the generated neural network architecture by using the computing device, and to determine whether performance of the generated neural network architecture satisfies a target performance by using the determined performance information.

8. The apparatus of claim 7, wherein the performance information comprises one or more indicators comprising any one or any combination of any two or more of learnability of the generated neural network architecture, training validation accuracy, training time, inference accuracy, and inference time of the generated neural network architecture.

9. The apparatus of claim 7, wherein in response to the target performance being satisfied, the performance comparison module is configured to determine the generated neural network architecture to be a final neural network architecture.

10. The apparatus of claim 7, wherein in response to the target performance not being satisfied, the performance comparison module is configured to store the setting information, result information of generating the neural network architecture, and the performance information in a memory.

11. The apparatus of claim 7, wherein the generating device further comprises a setting information update module configured to, in response to the target performance not being satisfied:
update the setting information by using new setting information; and
generate the neural network architecture again.

12. The apparatus of claim 11, wherein in response to the target performance not being satisfied, the performance comparison module is configured to:
determine whether a number of times that neural network architectures are generated so far exceeds a predetermined number of times; and
in response to the predetermined number of times being exceeded, determine one of the neural network architectures, generated so far, to be a final neural network architecture based on the performance information.

13. A processor-implemented method with hybrid quantum-classical neural network architecture generation, the method comprising:
receiving setting information for generating a neural network architecture; and
generating a hybrid quantum-classical layer based neural network architecture based on the setting information,
wherein the generating of the neural network architecture comprises:
determining, based on the setting information, whether to distribute neurons in each layer of the neural network into a quantum circuit or a classical circuit;
generating a quantum circuit for the each layer, based on a result of distribution into the quantum circuit; and
generating a classical circuit for the each layer, based on a result of distribution into the classical circuit.

14. The method of claim 13, wherein the setting information for generating the architecture comprises any one or any combination of any two or more of a total number of layers of a neural network architecture to be generated, a number of input neurons and output neurons in each layer, a probability that the respective neurons in the each layer are distributed into the quantum circuit or the classical circuit, and a number of output neurons of each of the quantum circuit and the classical circuit in the each layer.

15. The method of claim 13, wherein the generating of the neural network architecture further comprises verifying consistency of the each layer based on the determination of whether to distribute the neurons in the each layer into the quantum circuit or the classical circuit.

16. The method of claim 13, further comprising:
determining performance information of the generated neural network architecture by using a computing device; and
determining whether performance of the generated neural network architecture satisfies a target performance by using the determined performance information.

17. The method of claim 16, further comprising, in response to the target performance not being satisfied, storing the setting information, result information of generating the neural network architecture, and the performance information in a memory.

18. The method of claim 16, further comprising, in response to the target performance not being satisfied, updating the setting information by using new setting information, and generating a neural network architecture again based on the updated setting information.

19. The method of claim 18, further comprising:
in response to the target performance not being satisfied, determining whether a number of times that neural network architectures are generated so far exceeds a predetermined number of times; and
in response to the predetermined number of times being exceeded, determining one of the neural network architectures, generated so far, to be a final neural network architecture based on the performance information.

20. An electronic device comprising:
a neural network device including a hybrid quantum-classical neural network architecture generated by an apparatus for generating a hybrid quantum-classical neural network architecture; and
one or more processors configured to operate the hybrid quantum-classical neural network device, and to perform any one or any combination of any two or more of image processing, natural language processing, and applying artificial intelligence and machine learning,
wherein the hybrid quantum-classical neural network is generated by stochastically distributing neurons in one or more layers of the neural network into both a quantum circuit and a classical circuit.
